(19) United States
(12) Patent Application Publication
(10) Pub. No.: US 2016/0033072 A1
(43) Pub. Date: Feb. 4, 2016

(54) SHORT LINER FOR SEWER REHABILITATION

(71) Applicant: SAERTEX multiCom GmbH, Saerbeck (DE)

(72) Inventors: Frank MERSMANN, Saerbeck (DE); Heinz-Georg KAISER, Wettringen (DE)

(21) Appl. No.: 14/772,508

(22) PCT Filed: Mar. 5, 2014
(86) PCT No.: PCT/EP2014/054288

§ 371 Date: Sep. 3, 2015

(30) Foreign Application Priority Data
Mar. 6, 2013 (DE) 10 2013 203 840.2

(51) Int. Cl. F16L 55/163

(52) U.S. Cl. CPC F16L 55/163

(57) ABSTRACT

The invention relates to a multi-layer short liner suitable for sewer rehabilitation, a short liner kit suitable for sewer rehabilitation, comprising at least one individual layer of the short liner not impregnated with resin and at least one individual layer impregnated with a polyester resin, to a rehabilitation kit comprising a short liner or a short liner kit and comprising epoxy resin or silicate resin, to the use of a short liner or a short liner kit for sewer rehabilitation, and to a method for sealing a sewer, wherein a short profiled element is inserted into the sewer.

The invention relates to a multi-layer short liner suitable for canal rehabilitation, a short liner kit suitable for canal rehabilitation, comprising at least one individual layer of the short liner not impregnated with resin and at least one individual layer impregnated with a polyester resin, to a rehabilitation kit comprising a short liner or a short liner kit and comprising epoxy resin or silicate resin, to the use of a short liner or a short liner kit for canal rehabilitation, and to a method for sealing a canal, wherein a short profiled element is inserted into the canal.

So far, sealing of a damaged short canal section has been effected by a so-called short liner or part liner. Usually, this short liner is impregnated with an unsaturated polyester resin. This is of disadvantage in that unsaturated polyester resin is sensitive to water prior to curing and hence the attached short liners may become untight or be untight already during curing, adhere no longer and collapse. These short liners are later found again in wastewater treatment plants, for example. Sometimes the short liner is also impregnated with epoxy resin. However, in this case curing takes more than one hour even with heat curing, so that rehabilitation takes a very long time.

Short liners have been known from DE 10 2006 051 810 A1, for example. Also canal shafts are lined with liners as described in DE 20 2009 003 419 U1, however, said liners are not suitable for the canals themselves.

Accordingly, it is the object of the present invention to provide a technology that allows to seal off damaged areas in a canal in a fast and reliable manner.

According to a first embodiment, the object of the invention is achieved by a multi-layer short liner suitable for canal rehabilitation and having multiple layers over at least 80% of the entire length that contains at least two layers of non-woven fabric, woven fabric, non-crimp fabric, knitting, knitted fabric or chopped strand mat.

Such a short liner consists of several layers. Said layers can be laid on top of each other, for example. A short liner having several layers offers the advantage that an inner individual layer can be impregnated with a polyester resin for rapid curing and an outer individual layer can be impregnated with an epoxy resin for improved adhesion and leak tightness, for instance. This was not possible with existing technology. Now, sealing in canal rehabilitation can be performed in a much faster and more reliable manner.

Preferably, the short liner according to the invention consists of two individual layers. It is therefore preferably a double short liner. This offers the particular advantage that the above-mentioned advantages can be utilized in each of the layers and the short liner according to the invention still remains relatively thin. The diameter of the canal to be rehabilitated is not unnecessarily reduced.

The edges of the individual layers are preferably not sewn or welded to one another. Preferably, the edges of one individual layer only overlap. For example, the edges of the respective layers are solidly bonded to one another only by curing the resin in the finished product. Particularly preferably, the layers are no seamless tubes.

For example, the short liner according to the invention can at least partially be resin-impregnated and be either uncured or installed and cured.

Preferably, one of the layers that is not completely at the outside is impregnated with a polyester resin. This offers the particular advantage that only the individual layer at the outside has to be impregnated with epoxy resin or silicate resin on site prior to installation.

According to another embodiment, the object of the invention is achieved by a short liner kit suitable for canal rehabilitation comprising at least one individual layer of the short liner not impregnated with resin and at least one individual layer of the short liner impregnated with a polyester resin.

The individual layer impregnated with polyester resin is preferably packed, wherein the package is in particular impermeable to UV radiation.

In the multi-layer short liner according to the invention or in the short liner kit according to the invention at least one individual layer of the short liner preferably mainly consists of glass fibers. Consequently, the rehabilitated canal area is sealed and mechanically much more stable.

In the multi-layer short liner according to the invention or in the short liner kit according to the invention, at least one individual layer is preferably a woven or non-crimp fabric. Therefore, contrary to known layers, the layers are especially expansible and flexible. Seamlessness is particularly preferred since the layer can be particularly uniformly impregnated with resin due to the lack of seams. Preferably, a two-layer material is processed.

In the multi-layer short liner according to the invention or the short liner kit according to the invention, the polyester resin is preferably an unsaturated polyester resin (UP resin). Said resin is preferably photocurable. The polyester resin blend preferably contains at least one radical starter in such an amount that photocuring, especially with UV light, proceeds within 4 to 10 minutes.

Particularly preferably, the multi-layer short liner according to the invention or the short liner kit according to the invention consists of two layers of seamless woven or non-crimp fabric made of glass fibers.

In the multi-layer short liner according to the invention or the short liner kit according to the invention, an individual layer preferably has a length of at least 60 cm. This ensures an optimum leak tightness of the rehabilitated canal. An individual layer preferably has a length of up to 5 m, in particular up to 1 m. Preferably, the diameter of the canal to be rehabilitated is in a range from 5 to 500 cm, especially in a range from 20 to 100 cm. The short liner thickness is preferably in a range from 1 mm to 10 mm. Preferably, all layers of the multi-layer short liner have approximately the same length.

In the multi-layer short liner according to the invention or the short liner kit according to the invention, the weight per unit area of the non-impregnated material of one individual layer is preferably in a range from 700 to 3200 g/m², in particular in a range from 1200 to 2000 g/m².

In the multi-layer short liner according to the invention or the short liner kit according to the invention, the individual layers may consist of the same material, especially of glass fibers. In the multi-layer short liner according to the invention or the short liner kit according to the invention, at least the layer at the extreme outside may be impregnated with epoxy resin or silicate resin. In particular, the epoxy resin may contain bisphenol A, bisphenol F and/or 1,6-hexane diglycidyl ether. As a hardener, dipropylenetriamine and/or 2-piperazinoethylamine may be added to the epoxy resin. The weight ratio of epoxy resin or silicate resin to hardener may be in a range of 2:1 to 4:1. For example, the epoxy resin or silicate resin blend contains such an amount of the hardener that heat curing proceeds in range from 1 to 2 hours and cold curing in a range from 9 to 13 hours.

In the multi-layer short liner according to the invention or the short liner kit according to the invention, in one impregnated individual layer the weight ratio of an individual layer to resin may be in a range from 1:2 to 1:4. Insufficient bonding may result if the ratio is significantly smaller. Drop formation during installation may result if the ratio is significantly greater.

In another embodiment, the object of the invention is achieved by a rehabilitation kit comprising on the one hand a multi-layer short liner according to the invention or a short liner kit according to the invention and on the other hand an epoxy resin or a silicate resin.

In another embodiment, the object of the invention is achieved by a rehabilitated canal characterized in that the canal is sealed with a multi-layer short liner according to the invention.

Preferably, the canal is selected from a house connection canal, a canal, a fresh water channel, a drainage canal and/or a channel of free-flowing water. Preferably, the resin is cured. In another embodiment, the object of the invention is achieved by the use of a multi-layer short liner according to the invention or a short liner kit according to the invention for canal rehabilitation.

In another embodiment, the object of the invention is achieved by a method for sealing a canal wherein a multi-layer short liner according to the invention is inserted into the canal such that an individual layer as part of the multi-layer short liner butts against the inside of the canal and the outside of this individual layer butts against the inside of the canal and said individual layer is integrally bonded to the canal.

Preferably, the individual layer that is to be integrally bonded to the canal is impregnated with an epoxy resin or silicate resin just shortly before installation.

The short liner is preferably pressed against the inner wall of the canal by a setting tool. The setting tool may substantially consist of a balloon made of silicone, for example. The balloon may be inflated by compressed air in order to press the short liner, for example. Preferably, the silicone balloon does not contain a UV protection to allow a good curing of the polyester resin by UV light. For example, the balloon bulges into the side inlet canal and thus presses the short liner against the inner wall of the canal. In this step, for instance, the UV lamp is dragged along into the canal. Preferably, a UV light source is arranged within the setting tool. Prior to installation, the joint surface is preferably prepared, in particular roughened. Moreover, a high pressure flushing is performed prior to installation, for example. Preferably, the joint surface is put in a dust- and grease-free state prior to installation.

When inserting the multi-layer short liner into the canal to be rehabilitated, the short liner is preferably placed on and/or compressed to facilitate the positioning of the setting tool with the multi-layer short liner at the correct position within the canal to be rehabilitated. When applying compressed air to the setting tool, the short liner unfolds preferably in a wrinkle-free and homogeneous manner. In this way the balloon presses the multi-layer short liner according to the invention against the inner wall of the canal.

### EMBODIMENT

The damaged area of the inner wall of a sewer to be rehabilitated was cleaned by high pressure flushing. The surface in this area was roughened by rough milling. Subsequently, this area was cleaned again such that the surface was both dust-free and grease-free.

Then, a setting tool was provided. The setting tool substantially consisted of a balloon made of silicone. At one end of the balloon a compressed air connection and an electric connection were provided. A UV lamp was arranged within the balloon. The balloon material was not provided with a UV protection. The balloon was inflated with compressed air such that the balloon occupied approximately two-thirds of the diameter of the rehabilitated sewer.

A layer impregnated with UP resin was taken from a package impermeable to UV light, said layer being pre-impregnated with UP resin (UV light-curable, commercially available). This layer was wrapped around the balloon such that the edges of the layer overlapped. Then, the not yet impregnated layer at the outside was impregnated with epoxy resin on site. For this purpose the Saertex® Yellow HP-EP product was used. This layer impregnated with epoxy resin was placed on the layer pre-impregnated with UP resin. The length was 80 cm. The individual layers consisted of non-crimp glass fiber fabric having a weight per unit area of 1,500 g/m² each. Thus, the multi-layer short/part liner according to the invention was obtained. Then the setting tool with the multi-layer short liner according to the invention was placed immediately adjacent to the prepared damaged area. Subsequently, compressed air was applied to the setting tool such that the two separate layers were pressed against the inner wall of the sewer.

Subsequently, the UV lamp was activated for 7 minutes. In this way the polyester-impregnated layer was completely cured. Due to the exothermic reaction of the UP resin, also the epoxy resin-impregnated layer of the multi-layer short liner was partially through-polymerized or curing was accelerated.

The setting tool was removed and the rehabilitated sewer could be put into operation again. The epoxy resin completely cured in the following 10 hours.

The tensile bond strength according to DIN EN 1542 and DIN EN ISO 4624 was 4.25 MPa (N/mm²) on the average (stoneware/PVC). In a total of 12 tests, the standard deviation was 1.09 MPa. The transition area was completely airtight.

In a comparative test, epoxy resin was applied to an individual layer impregnated with UP resin. Otherwise, the comparative test was carried out in the same way. The tensile bond strength according to DIN EN 1542 and DIN EN ISO 4624 was at least 30% lower than in the example according to the invention.

The features of the invention disclosed in the present description, in the drawings as well as in the claims both individually and in any combination may be essential to the realization of the various embodiments of the invention.

### LIST OF REFERENCE NUMERALS

1 Multi-layer short liner

3 Individual layer (not completely at the outside)

5 Individual layer (at the outside)

1. A multi-layer short liner adapted for canal rehabilitation and having multiple layers over at least 80% of the entire length containing at least two layers of non-woven fabric, woven fabric or non-crimp fabric.

2. The short liner according to claim 1, wherein one of the multiple layers that is not completely at the outside is impregnated with a polyester resin.

3. A short liner kit suitable for canal rehabilitation comprising at least one individual layer of the short liner not impregnated with resin and at least one individual layer of the short liner impregnated with a polyester resin.

4. The short liner according to claim 1, wherein at least one layer of the short liner mainly consists of glass fibers.

5. The short liner according to claim 1, wherein at least one layer of the short liner is woven or non-crimp fabric.

6. The short liner according to claim 2, wherein the polyester resin is an unsaturated polyester resin.

7. The short liner according to claim 1, wherein the at least two layers consists of two layers of woven or non-crimp fabric made of glass fibers.

8. The short liner according to claim 1, wherein a diameter of the short liner is in a range from 5 to 500 cm.

9. The short liner according to claim 1, wherein a weight per unit area of a material of at least one layer of the short liner is in a range from 700 to 2100 g/m².

10. A rehabilitation kit comprising the short liner according to claim 1, wherein at least an outermost layer of the multiple layers is impregnated with an epoxy resin or silicate resin.

11. A rehabilitated canal characterized in that the canal is sealed with the short liner according to claim 1.

12. A method comprising using the short liner according to claim 1 for canal rehabilitation.

13. A method for sealing a canal wherein the short liner according to claim 1 is inserted into the canal such that an individual layer of the multi-layer short liner butts against the inside of the canal and an outside of this individual layer butts against the inside of the canal and said individual layer is integrally bonded to the canal.

14. The method according to claim 13, wherein the individual layer is impregnated with an epoxy resin or silicate resin that is to be bonded to the canal wall in a non-positive and/or positive fit, wherein the individual layer is impregnated with the epoxy resin or the silicate resin just shortly before installation.
